(19) United States
(12) Patent Application Publication
(10) Pub. No.: US 2016/0206036 A1
(43) Pub. Date: Jul. 21, 2016

(54) CIRCUIT DEVICE AND AN OBJECT EMBEDDING THE SAME

(71) Applicant: Shen-Ko Tseng, Taipei City (TW)

(72) Inventor: Shen-Ko Tseng, Taipei City (TW)

(21) Appl. No.: 14/996,243

(22) Filed: Jan. 15, 2016

(30) Foreign Application Priority Data
Jan. 16, 2015 (CN) 201520029999.2

(51) Int. Cl. A43B 3/00; F21V 8/00; H05B 37/02; F21V 23/04

(52) U.S. Cl. CPC A43B 3/001; F21V 23/0471; G02B 6/0006; G02B 6/001; H05B 37/0227; H05B 37/029; F21Y 2101/02

(57) ABSTRACT

The present invention provides a light-emitting module and light-emitting shoes. The light-emitting module comprises an actuated switch, a controller, a light-emitting device, and a battery. The light-emitting device comprises a light-emitting diode (LED) and an optical fiber. The optical fiber comprises a covering layer and a guiding layer. The covering layer and the guiding layer have the slots for enhancing the lighting effect of the light-emitting device. The light-emitting shoes comprise a shoe body with an external surface, a bottom, and the light-emitting module mentioned above. The actuated switch, the controller, and the light-emitting device are disposed on the bottom, and the light-emitting device is disposed on the external surface and/or the bottom. Compared to the prior art, the present invention provides more kinds of lighting/shining patterns for providing eye-catching and sufficient illumination in night activities.

### BACKGROUND OF THE INVENTION

1. Field of the Invention

The present invention relates to a light-emitting module; more particularly, the present invention relates to a shoe utilizing the light-emitting module to light according to the motion of the feet when the user is walking or exercising.

2. Description of the Prior Art

Insufficient lighting is not good for activities at night, which will easily cause some security problems or identification problems. While running or riding at night, people might be hit by cars due to insufficient lighting. Additionally, if the streetlight is not bright enough, people probably could not play sports in the courts at night. Therefore, it's necessary to develop a device which may increase the security of activities at night for allowing the activities at night to be performed successfully.

Due to the security consideration mentioned above, many shoes comprising light-emitting element are presented to the public. This kind of shoes generally comprises at least one light source (e.g. a light-emitting diode), a power source (e.g. a battery), and a switch (used to connect the battery to the light source for guiding the electrical power to the light source for lighting).

Additionally, the switch can be a simple hand-operated switch which is similar to the hand-operated switch disclosed in the U.S. Pat. No. 4,158,922. The switch also can be a mercury switch. In the mercury switch, a mercury ball can roll back and forth according to the motion of a user in a tube pillar set between a pair of electrodes. More relative description of the mercury switch can be referred in the U.S. Pat. No. 4,848,009. Additionally, the switch also can be a pressure responsive switch, which can respond the weight applied by the user for turning on/off the pressure responsive switch, such as the pressure responsive switch disclosed in the U.S. Pat. No. 5,285,586. Furthermore, the switch can be a spring switch disclosed in the U.S. Pat. No. 5,408,764. The spring switch can vibrate back and forth for forming/breaking the connection with an electrode.

To prolong the life of the battery and provide more noticeable and safer display, the lighting is hoped to be controllable for lighting intermittently, and the lighting is not hoped to light continuously after the switch is switched off. If a noticeable blinking pattern can be generated by light-emitting diodes, the noticeable blinking pattern will be very interesting and noticeable.

### SUMMARY OF THE INVENTION

Therefore, the present invention provides a light-emitting module; more particularly, the light-emitting module is able to integrate with a shoe to form a light-emitting shoes lighting according to the motion of the feet when the user is walking or exercising. Otherwise, the present invention provides more kinds of lighting/shining patterns for providing eye-catching and sufficient illumination in night activities.

The present invention in an embodiment provides a light-emitting module, comprising: an actuated switch, a controller, a light-emitting device and a battery. Wherein the actuated switch generates a trigger signal in response to a motion of the light-emitting module; the controller is electrically coupled to the motion actuated switch; the light-emitting device is electrically coupled to the controller (the light-emitting device comprises a plurality of light-emitting diodes triggered to light in a lighting mode by the controller according to the trigger signal, a coupled tube and an optical fiber, and the light-emitting diodes are coupled with the optical fiber through the coupled tube); and a battery supplies the motion actuated switch, the controller, and the plurality of light-emitting devices with electrical power.

Wherein the optical fiber comprises a guiding layer and a covering layer for covering the guiding layer, the covering layer is a transparent layer, and the guiding layer is a colored layer. The light-emitting diodes are triggered to flash based on a lighting mode by the controller according to the trigger signal when the controller receives the trigger signal. The plurality of light-emitting diodes corresponding to a plurality of sub-fibers transmit and present the light.

The light-emitting shoes of the present invention in an embodiment for lighting according to a feet motion when a user is walking or exercising, comprising: a shoe body, an actuated switch, a controller, a light-emitting device and a battery.

Wherein the shoe body comprises an external surface and a bottom. An actuated switch is disposed on the bottom, and the actuated switch generates a trigger signal in response to a motion of a light-emitting module. The controller is electrically coupled to the actuated switch and disposed on the bottom. The light-emitting device is disposed on the external surface and/or the bottom, and the light-emitting device is electrically coupled to the controller, wherein the light-emitting device comprises a light-emitting diode, a coupled tube and an optical fiber, and the light-emitting diode is coupled with the optical fiber through the coupled tube. A battery supplies the actuated switch, the controller, and the light-emitting device with electrical power.

Wherein the optical fiber comprises a guiding layer and a covering layer. The covering layer is a transparent layer, the guiding layer is a colored layer, and the covering layer covers the guiding layer. The light-emitting diodes are triggered to flash based on a lighting mode by the controller according to the trigger signal when the controller receives the trigger signal. The plurality of light-emitting diodes corresponding to a plurality of sub-fibers transmit and present the light. The guiding layer comprises a plurality of dyed particles to form the colored layer.

Compared to the prior art, the present creation provides a variety of lighting/shining patterns for providing eye-catching and sufficient illumination in night activities.

The advantages and spirits of the invention may be understood by the following recitations together with the appended drawings.

### BRIEF DESCRIPTION OF THE APPENDED DRAWINGS

Some of the embodiments will be described in detail, with reference to the following figures, wherein like designations denote like members, wherein:

FIG. 1 shows the explosion diagram of the light-emitting module of the present invention in an embodiment.

FIG. 2A shows the diagram of the shining function of the present invention in an embodiment.

FIG. 2B shows the diagram of the shining function of the present invention in an embodiment.

FIG. 2C shows the diagram of the shining function of the present invention in an embodiment.

FIG. 3A to FIG. 3D show the diagram of the optical fibers in a plurality of embodiments.

FIG. 4A and FIG. 4B show the sectional view and the lateral view of the optical fiber in an embodiment, wherein FIG. 4A is the lateral view according to the line I-I of FIG. 4B.

FIG. 4C and FIG. 4D show the sectional view and the lateral view of the optical fiber in an embodiment, wherein FIG. 4C is the lateral view according to the line II-II of FIG. 4D.

FIG. 4E and FIG. 4F show the sectional view and the lateral view of the optical fiber in an embodiment, wherein FIG. 4E is the lateral view according to the line III-III of FIG. 4F.

FIG. 4G and FIG. 4H show the sectional view and the lateral view of the optical fiber in an embodiment, wherein FIG. 4G is the lateral view according to the line IV-IV of FIG. 4H.

FIG. 5 shows the diagram of the light-emitting shoes of the present invention in an embodiment.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

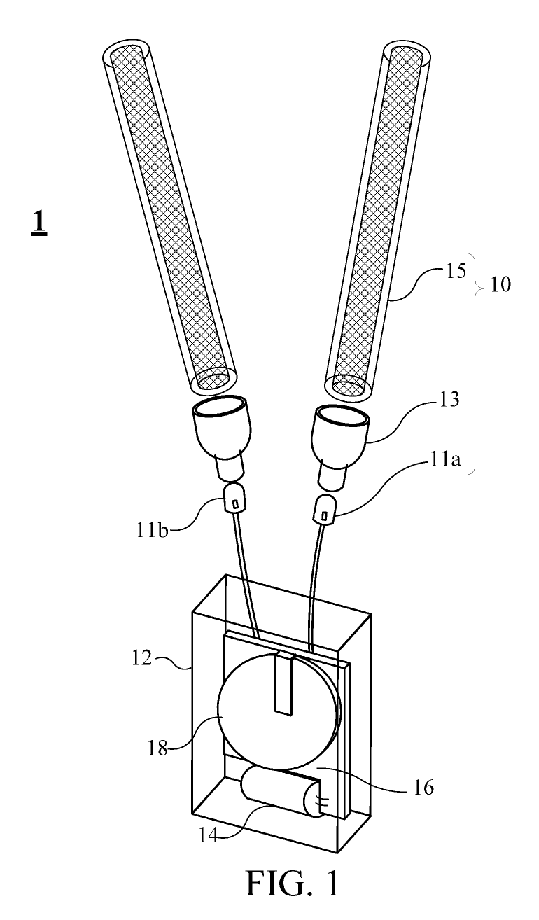

Please refer to FIG. 1. FIG. 1 shows the explosion diagram of the light-emitting module of the present invention in an embodiment. The light-emitting device 10 is triggered to light in a lighting mode according to the light-emitting module 1. And, the light-emitting module 1 of the present invention comprises a light-emitting device 10, a cover 12, an actuated switch 14, a controller 16 and a battery 18.

Wherein the light-emitting device 10 comprises light-emitting diodes 11a and 11b, a coupled tube 13 and an optical fiber 15; the light-emitting diodes 11a and 11b are connected with the optical fiber 15 through the coupled tube 13, and the coupled tube 13 is a heat-shrunk tube. The amount of the light-emitting device 10 can be adjustable according to the needs of the user. For example, the amount of the light-emitting device 10 is two in this embodiment.

According to an embodiment of the present invention, the actuated switch 14 is configured on the cover 12 in response to a motion like a movement or a vibration when an external force is applied to the light-emitting module 1, and the controller 16 is triggered. In other word, when the object moves or vibrates, the actuated switch 14 generates a trigger signal to the controller 16. Otherwise, the controller 16 is also configured on the cover 12 and electrically coupled to the actuated switch 14 and every light-emitting device 10 to trigger the light-emitting device 10 to light in a lighting mode according to the trigger signal when the actuated switch 14 is triggered. In other word, the light-emitting device 10 is triggered to flash based on the lighting mode after the controller 16 receives the trigger signal. The lighting mode is preset.

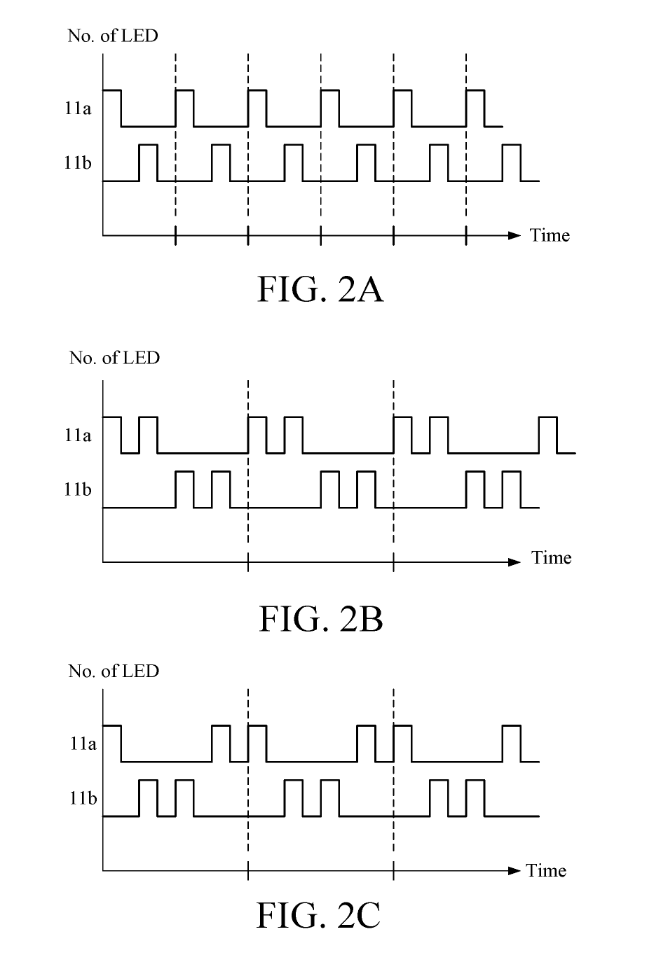

Please refer to FIG. 2A to FIG. 2C. FIG. 2A shows the diagram of the shining function of the present invention in an embodiment. FIG. 2B shows the diagram of the shining function of the present invention in an embodiment. FIG. 2C shows the diagram of the shining pattern of the present invention in an embodiment. Wherein the horizontal axes of the FIG. 2A to FIG. 2C are the time axis, the vertical axes of the FIG. 2A to FIG. 2C are the number of the light-emitting diode, and the peak of the square wave means that the diode is lighting. The scale of the horizontal axis and the dotted line of the diagram refer to the period and the content of a lighting mode.

Please refer to FIG. 2A. The lighting mode means that the controller 16 triggers the plurality of light-emitting diodes 11a and 11b first flash separately and sequentially, and then repeat the sequence of flashes N times, wherein the N is a natural number. Also, please refer to FIG. 2B. The lighting mode means that the controller 16 sequentially triggers the plurality of light-emitting diodes 11a and 11b flashing twice to form a cycle, and then repeats the cycle N times, wherein the N is a natural number. Then, please refer to FIG. 2C. The lighting mode means that the controller 16 triggers the plurality of light-emitting diodes 11a and 11b flashing in sequence and then flashing in reverse sequence to form a cycle, and then repeats the cycle N times, wherein the N is a natural number.

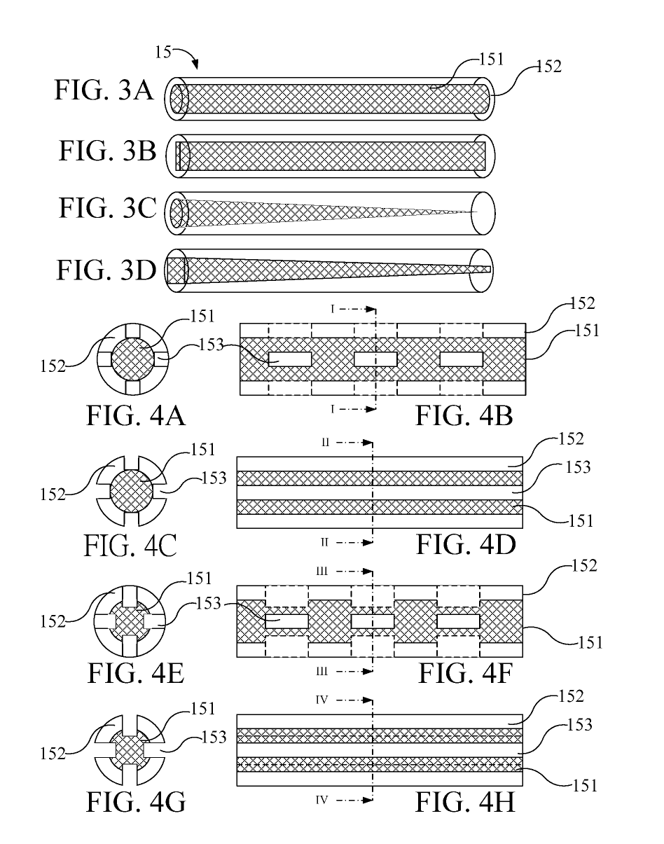

Please refer to FIG. 3A to FIG. 3D. FIG. 3A to FIG. 3D show the diagram of the optical fiber in a plurality of embodiments. The optical fiber 15 in the embodiment comprises a guiding 151 and a covering layer 152, wherein the covering 152 is a transparent layer, the guiding layer 151 is a colored layer, and the covering layer 152 covers the guiding layer 151. Besides, the shape of the guiding layer 151 can be cylindrical (like FIG. 3A), conical (like FIG. 3B), taper (like FIG. 3C) or ribbon (like FIG. 3D). The shape of the guiding layer 151 is not limited to cylindrical, conical, taper and ribbon. The colored guiding layer comprises a plurality of dyed particles to form the colored layer.

Please refer to FIG. 4A to FIG. 4H. FIG. 4A and FIG. 4H show the sectional view and the lateral view of the optical fiber in an embodiment, wherein FIG. 4A, FIG. 4C, FIG. 4E and FIG. 4G are the lateral views according to the line I-I of FIG. 4B, the line II-II of FIG. 4D, the line III-III of FIG. 4F and the line IV-IV of FIG. 4H respectively.

Please refer to FIG. 4A and FIG. 4B. A plurality of slots 153 are disposed on the covering layer 152 of the optical fiber 15 to improve the lighting impression of the light-emitting device. The shape of the slot 153 can be square, showed in FIG. 4A and FIG. 4B, or long strip showed in FIG. 4C and FIG. 4D. The shape and the disposing method of the slot 153 are not limited to the shape and the disposing method showed in the figures. The shape and the disposing method are adjustable for the needs of the user.

Please refer to FIG. 4E and FIG. 4F. The slot 153 is able to be disposed on the light-introduced layer 151 of the optical fiber 15 to improve the lighting impression of the light-emitting device. And the disposing methods of the slot 153 of FIG. 4E, FIG. 4F, FIG. 4G and FIG. 4H are as same as the disposing methods of the slot 153 of FIG. 4A to FIG. 4D.

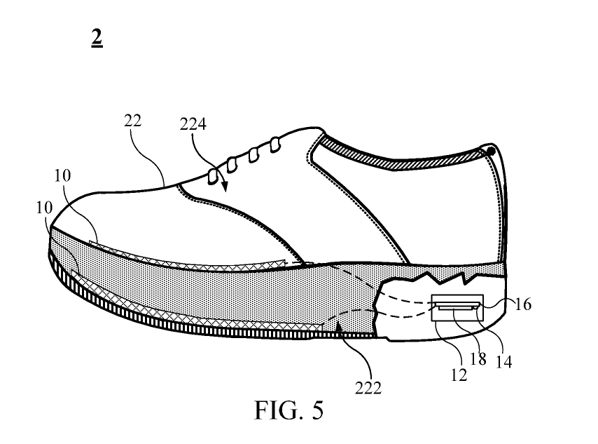

Please refer to FIG. 5. FIG. 5 shows the diagram of the light-emitting shoes of the present invention in an embodiment. A light-emitting shoes 2 of the present invention in another better embodiment is able to light according to the motion of feet when a user is walking or exercising, comprising: a shoe body 22, a light-emitting device 10, a cover 12, an actuated switch 14, a controller 16 and a battery 18.

Please refer to FIG. 5. The shoe body 22 comprises an external surface 224 and a bottom 222; the cover 12 comprises the actuated switch 14, the controller 16 and the battery 18 disposed on the bottom 222; the light-emitting device 10 is able to be disposed on the external surface 224 and/or the bottom 222.

Wherein the light-emitting device 10 comprises light-emitting diodes 11a and 11b, a coupled tube 13 and an optical fiber 15; the light-emitting diodes 11a and 11b are coupled to the optical fiber 15 through the coupled tube 13, and the coupled tube 13 is a heat-shrunk tube. In the embodiment of the present invention, the amount of the light-emitting device 10 is adjustable for the needs of the user. The amount of the light-emitting device 10 is two.

According to the embodiments of the present invention, the actuated switch 14 is configured on the cover 12 in response to a motion like a movement or a vibration when an external force is applied to the light-emitting module 1, and the controller 16 is triggered. In other words, the actuated switch 14 generates a trigger signal to controller 16 when the feet of the user move. Otherwise, the controller 16 is also configured on the cover 12 and electrically coupled to the actuated switch 14 and every light-emitting device 10 to trigger the light-emitting device 10 to flash based on a lighting mode according to the trigger signal when the actuated switch 14 is triggered. In other words, the light-emitting device 10 is triggered to flash based on the lighting mode after the controller 16 receives the trigger signal. The lighting mode is preset. And the lighting mode of the light-emitting device 10 and the shape of the optical fiber 15 are mentioned before.

To summary, the present invention provides a light-emitting module and a light-emitting shoe integrating the light-emitting module. The light-emitting module comprises an actuated switch disposed on the cover, a controller, a battery and a light-emitting device disposed on the cover and electrically coupled to the controller. The actuated switch are electrically coupled to the controller, and the battery provides the actuated switch, the controller and the light-emitting device power, wherein the light-emitting device comprises a light-emitting diode, an optical fiber and a coupled tube electrically coupling the optical fiber and the light-emitting diode. When an external force like the motion of the feet of the user is applied to the actuated switch, a trigger signal is generated to the controller, the controller triggers the light-emitting diode to light in the lighting mode according to the trigger signal, and the optical fiber transmits and presents the lighting mode. Wherein the optical fiber comprises a covering layer and a guiding layer, wherein the covering layer is a transparent layer, a covering layer and/or a guiding layer disposed by a slot to improve the lighting impression of the light-emitting device. And the light-emitting shoes comprise a shoe body and the light-emitting module mentioned above. The shoe body comprises an external surface and a bottom, wherein an actuated switch, a controller and a cover of the battery are disposed on the bottom of the shoe body, and the light-emitting device is disposed on the external surface and/or the bottom.

Compared to the prior art, the present creation provides a variety of lighting/shining patterns for providing eye-catching and sufficient illumination in night activities.

What is claimed is:

1. A light-emitting module, comprising:
an actuated switch generating a trigger signal in response to a motion of the light-emitting module;
a controller electrically coupled to the motion actuated switch;
a light-emitting device electrically coupled to the controller, the light-emitting device comprising a plurality of light-emitting diodes, a coupled tube and an optical fiber, the plurality of light-emitting diodes triggered to flash based on a lighting mode by the controller according to the trigger signal, and the plurality of light-emitting diodes coupled with the optical fiber by the coupled tube; and
a battery supplying the motion actuated switch, the controller, and the plurality of light-emitting devices with electrical power;
wherein the optical fiber comprises a guiding layer and a covering layer disposed over the guiding layer, and the guiding layer is a colored layer.

2. The light-emitting module of claim 1, wherein the covering layer is a transparent layer.

3. The light-emitting module of claim 2, wherein the transparent layer comprises a slot.

4. The light-emitting module of claim 2, wherein the guiding layer comprises a slot.

5. The light-emitting module of claim 2, wherein the shape of the guiding layer is cylindrical, conical, taper or ribbon.

6. The light-emitting module of claim 1, wherein the coupled tube is a heat-shrunk tube.

7. The light-emitting module of claim 1, wherein the lighting mode is that the plurality of light-emitting diodes first flash separately and sequentially, and then simultaneously flash N times, wherein the N is a natural number.

8. The light-emitting module of claim 1, the plurality of light-emitting diodes lighting in a sequence, and the optical fiber comprising a plurality of sub-fibers respectively corresponding to the plurality of light-emitting diodes.

9. The light-emitting module of claim 1, wherein the colored guiding layer comprises a plurality of dyed particles.

10. A light-emitting shoes, for lighting according to a foot movement when a user is walking or exercising, comprising:
a shoe body comprising an external surface and a bottom;
an actuated switch generating a trigger signal in response to a motion of a light-emitting module and disposed on the bottom;
a controller electrically coupled to the actuated switch and disposed on the bottom;
a light-emitting device electrically coupled to the controller, the light-emitting device comprises a plurality of light-emitting diodes, a coupled tube and an optical fiber, the plurality of light-emitting diodes triggered to flash based on a lighting mode by the controller according to the trigger signal, and the plurality of light-emitting diodes coupled with the optical fiber by the coupled tube; and
a battery supplying the motion actuated switch, the controller, and the plurality of light-emitting devices with electrical power;
wherein the optical fiber comprises a guiding layer and a covering layer disposed over the guiding layer, and the guiding layer is a colored layer.

11. The light-emitting shoes of claim 10, wherein the covering layer is a transparent layer.

12. The light-emitting shoes of claim 11, wherein the transparent layer comprises a slot.

13. The light-emitting shoes of claim 12, wherein the guiding layer comprises a slot.

14. The light-emitting shoes of claim 12, wherein the shape of the guiding layer is cylindrical, conical, taper or ribbon.

15. The light-emitting shoes of claim 10, wherein the coupled tube can be a heat-shrunk tube.

16. The light-emitting shoes of claim 10, wherein the colored guiding layer comprises a plurality of dyed particles.
